(19) United States
(12) Patent Application Publication
(10) Pub. No.: US 2024/0146835 A1
(43) Pub. Date: May 2, 2024

(54) VIRTUAL DEVICES IN THE METAVERSE

(71) Applicant: Meta Platforms Technologies, LLC, Menlo Park, CA (US)

(72) Inventors: Gabriel Cohen, Alameda, CA (US); Bernhard Poess, Redmond, WA (US)

(21) Appl. No.: 18/499,764

(22) Filed: Nov. 1, 2023

Related U.S. Application Data
(60) Provisional application No. 63/382,019, filed on Nov. 2, 2022.

(51) Int. Cl. H04M 1/72409; G06F 3/16; G06T 15/20; H04M 1/72436; H04M 1/72439

(52) U.S. Cl. CPC H04M 1/72409; G06F 3/167; G06T 15/205; H04M 1/72436; H04M 1/72439; H04M 1/72427

(57) ABSTRACT

Techniques described herein enable a virtual mobile device representing a user's physical mobile device to be used in artificial reality, such as VR, MR, and AR. An artificial-reality head-mounted device worn by a user may present to the user a virtual mobile application on a virtual mobile device in a virtual environment. The virtual mobile application is a virtual representation of a mobile application that is native to an operating system of a physical mobile device. In particular embodiments, the mobile application may be hosted on a virtual machine for the operating system, which may be different from the operating system of the artificial-reality headset. The user may interact with the virtual mobile application in three-dimensional space. The artificial-reality device may translate the interactions into mobile-application-compatible data that can be understood by the mobile application. The mobile-application-compatible data is then sent to the native application for processing.

### PRIORITY

This application claims the benefit under 35 U.S.C. § 119 of provisional application 63/382,019, filed Nov. 2, 2022, the entire contents of which are hereby incorporated by reference for all purposes as if fully set forth herein.

### TECHNICAL FIELD

This disclosure generally relates to artificial reality environments, including virtual reality environments and mixed virtual reality environments.

### BACKGROUND

People today rely on their mobile phones for a variety of purposes, including communicating with friends, gaming, banking, music, etc. The ecosystem of mobile applications (“applications”) available on mobile phones is immense and extremely convenient, as there is an application for almost everything. Even while using an artificial-reality headset and being immersed in virtual reality (VR), augmented reality (AR), or mixed reality (MR), people my still want to use their mobile devices, such as a phone or tablet. One option for a user to do so is to simply take off their AR/VR/MR head-mounted device (“HMD” or “headset”) and use their physical mobile devices. However, doing so would break the experience of being immersed in the VR/AR/MR environment. Another solution is to install the user's favorite application natively on the headset so that the user may use the application without breaking the immersive experience. However, currently the ecosystem of applications on VR/AR/MR devices simply is not as vast as it is on mobile phones, and requiring app developers to support yet another platform may be cost prohibitive. In addition, due to the resource limitations of AR/VR/MR headsets, it may not be feasible to run certain applications on them.

### SUMMARY OF PARTICULAR EMBODIMENTS

Embodiments described herein enable a user of an AR/VR/MR headset, which may also be referred to as an artificial-reality headset, to interact with a virtual mobile phone while immersed in the metaverse. The virtual mobile phone may correspond to the user's physical mobile phone, including any installed applications. For example, if the user has a banking and social networking app installed on their physical mobile device, the same apps would be accessible to the user while the user is in virtual reality. When instructed, the user's AR/VR/MR headset would render a virtual mobile phone, through which the user could access the banking and/or social networking app corresponding to the ones installed on the user's physical mobile device. In particular embodiments, the apps available on the virtual mobile device may be hosted on a virtual machine on a server. The virtual machine could support a particular operating system for which the apps were developed. Through the virtual machine, existing apps native to that operating system could be ported into the metaverse without requiring app developers to build apps native to the AR/VR/MR device. User would be able to enter the metaverse via their AR/VR/MR device, launch a virtual mobile phone, and access the apps that are install on their physical mobile phone.

One issue, however, is that an application native to the operating system of a mobile phone expects a certain type of input/output that is available on the mobile phone (e.g., tap and swipe gestures, IMU, GPS, camera, etc.). For example, when the application is running on a server and being shown to the end user on a remote headset, the application would not be able to have access to the same input/output mechanisms since the user is interacting with a virtual mobile phone and not a physical one that has built in touch sensors, IMU, GPS, cameras, etc.

Thus, in one embodiment, the software platform (e.g., operating system or the software generating the virtual mobile device) running on the AR/VR/MR headset may perform a translation of the user's VR/MR/AR-based inputs into inputs understood by mobile-phone applications. For example, in VR/MR/AR, the input mechanisms available may be hand-held controllers, 3D hand gestures, or a virtual laser pointer (e.g., a ray may be cast from the user's controllers or fingertip to allow the user to point and select objects). The VR/MR/AR platform would understand such inputs, but the apps native to a mobile phone would not. Native apps of a mobile phone are designed to operate based on 2D touch-screen events, such as taps, swipes, pinches, etc. Thus, the VR/MR/AR would need to translate the user's inputs for the virtual mobile phone into corresponding inputs for the apps native to a physical phone.

Particular embodiments described herein relate to techniques for translating inputs from an AR/VR/MR headset into an input capable of being understood by a mobile application. At a high-level, a computing system associated with an artificial reality system may perform the steps of: launching, on an artificial-reality head-mounted device worn by a user, a virtual mobile application on a virtual mobile device in a virtual environment, wherein the virtual mobile application is a virtual representation of a mobile application that is (a) native to an operating system of a physical mobile device and (b) executing on a virtual machine for the operating system; receiving sensor data from the artificial-reality head-mounted device, the sensor data corresponding to an instruction, performed by the user in a three-dimensional space, that instructs the virtual mobile application; generating, based on the sensor data, mobile-application-compatible data corresponding to the instruction, the mobile-application-compatible data comprising emulated touch-screen events supported by the operating system; transmitting the mobile-application-compatible data to the mobile application executing on the virtual machine to cause the mobile application to render a frame corresponding to an output of the mobile application in response to the mobile-application-compatible data; and outputting, by the artificial-reality head-mounted device, a virtual representation of the frame for display on the virtual mobile device. In particular embodiments, the virtual machine executing the mobile application is on a server.

In particular embodiments, wherein the step of receiving sensor data from the artificial-reality head-mounted device comprises one or more of: receiving, from one or more image sensors, data corresponding to a position, movement, or gesture of a hand or finger of the user; receiving, from one or more sensors of a hand-held controller associated with the artificial-reality head-mounted device, one or more of: position data, orientation data, gesture data, or button activation data associated with a button, trigger, or joystick of the hand-held controller; or receiving, from one or more audio sensors, audio data from an user corresponding to an action on mobile device.

In particular embodiments, the step of receiving sensor data from the artificial-reality head-mounted device comprises receiving data indicating a location on the virtual mobile application intersected by the hand-held controller, hand, or finger.

In particular embodiments, the computing system associated with an artificial reality system may perform the steps of receiving text data input by the user on a native virtual keyboard of the artificial-reality head-mounted device; and transmitting the text data to the mobile application.

In particular embodiments, the mobile-application-compatible data comprises one or more of: a tap event, swipe event, or pinch event.

In particular embodiments, the computing system associated with an artificial reality system may perform the steps of receiving a requested from the mobile application to access a camera feed; in response to the request, determining a pose of the virtual mobile device in the virtual environment; determining a virtual camera viewpoint based on the pose of the virtual mobile device; rendering one or more images of the virtual environment from the virtual camera viewpoint; and transmitting the one or more images to the mobile application.

In particular embodiments, the computing system associated with an artificial reality system may perform the steps of determining, based on the sensor data, an orientation of the virtual mobile device, wherein the orientation corresponds to a position of a virtual camera of the virtual mobile device relative to the virtual environment. The virtual camera viewpoint may be relative to the virtual environment. The pose of the virtual mobile device is determined based on hand-tracking data corresponding to a hand of a user and a defined spatial relationship between the hand and the virtual mobile device.

In particular embodiments, the computing system associated with an artificial reality system may perform the steps of: upon a determination that the user is within a predetermined distance from the physical mobile device, transmitting, to the artificial-reality head-mounted device of the user, an invitation to launch the virtual mobile device; and upon receiving a request from the user to launch the virtual mobile device, launching the virtual mobile device on the artificial-reality head-mounted device of the user.

In particular embodiments, the computing system associated with an artificial reality system may perform the steps: in response to a determination that the mobile application received a notification, launching, on the artificial-reality head-mounted device, the virtual mobile application on the virtual mobile device and display a virtual representation of the notification.

In particular embodiments, the computing system associated with an artificial reality system may further perform steps comprising: registering the artificial-reality head-mounted device with the physical mobile device; identifying a plurality of mobile applications installed on the physical mobile device; and displaying icons associated with the plurality of mobile applications on the virtual mobile device. The launching of the virtual mobile application on the virtual mobile device may be triggered by a detection of a user selection of one of the icons associated with the mobile application.

The embodiments disclosed herein are only examples, and the scope of this disclosure is not limited to them. Certain embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example method for translating inputs from an AR/VR/MR headset into an input capable of being understood by a mobile application native to a mobile device, such as a mobile phone.

FIG. 2 illustrates an example view of a virtual reality environment in which a user interacts with a virtual mobile application on a virtual mobile device.

FIGS. 3A-3C illustrate an example view of a user capturing a photo using a virtual mobile device.

FIG. 4 illustrates an example mixed reality environment in which different users interact with different instances of an application on their respective artificial-reality headsets.

FIG. 5 illustrates an example of a mobile application being configured to display different types of content depending on whether the user is using the application in virtual reality.

FIG. 6 illustrates an example network environment.

FIG. 7 illustrates an illustrates an example artificial reality system and user.

FIG. 8 illustrates an example computer system for the artificial-reality system.

### DETAILED DESCRIPTION

Particular embodiments described herein allow users to unstow and use virtual equivalents of their favorite computing devices, such as mobile phones, tablets, TVs, laptops, and more, while immersed in virtual reality. As used herein, “mobile device” can be a mobile phone, tablet, TV, laptop, etc. These virtual devices may replicate the full catalog of software experiences and therefore utility of their physical analogs without dramatically impacting resource utilization of the host artificial-reality device. For example, a user wearing a VR/MR/AR headset may request for a virtual mobile device to be displayed. The virtual mobile device, in some embodiments, may correspond to the user's physical mobile device. On the virtual mobile device, the user could use applications that are designed to run natively on the operating system of the physical mobile device. The applications, however, may not be actually installed or running on the headset. Instead, the applications may be running on a server, which could be tasked with providing the rendered frames to the headset and processing inputs from the user's headset. Having the applications be hosted on a server has several benefits. For example, the mobile applications do not need to be installed on the user's artificial-reality headset, which has limited resources (e.g., storage, memory, compute, power). A server would have more computational resources to host a virtual machine for executing native applications.

In another embodiment, an artificial-reality headset may directly communicate with a physical mobile phone of the user. An interface layer—which may be executing on the artificial-reality device and/or the physical mobile phone—may bridge the communication. For example, when a virtual mobile phone is launched on the artificial-reality headset, the virtual mobile phone will obtain icons of mobile applications installed on the physical mobile phone and display them on the virtual mobile phone. When the user selects an icon via the virtual mobile phone, the artificial-reality device would send a signal to the physical mobile phone, which in turn would launch the corresponding mobile application. The frame rendered by the mobile application may then be transmitted back to the artificial-reality device so that a virtual representation of the frame could be displayed on the virtual mobile phone. The interface layer may also perform various input translation services. For example, when the user interacts with the virtual mobile device using 3D gestures, the interface layer may translate such input into a compatible format that could be consumed and interpreted by the operating system and native mobile application running on the physical mobile phone. As another example, when the mobile application requests access to a camera, the interface layer would cause a virtual camera of the virtual mobile device to capture images of the virtual environment. The captured images would then be sent to the mobile application on the physical phone and used as if they were captured by the physical camera of the physical mobile phone. Additional details of the input translation feature are described in further detail below.

In yet another embodiment, an instance of the mobile application may be installed on the artificial-reality device itself. Since the mobile application may be designed for an operating system different from the one used by the artificial-reality device, the device would run the mobile application via a virtual machine. An interface layer, similar to the one described above, would perform the task of translating inputs/outputs so that virtual mobile applications running on the artificial-reality device can function based on corresponding mobile applications that are native to a different platform.

The aforementioned virtual machine, which may emulate one or more mobile operating systems of a mobile device, may be different from the operating system of the artificial-reality device. The virtual machine may run a variety of applications that are native to those mobile operating systems. In particular embodiments, the mobile application is running on a virtual machine hosted by a server. In other embodiments, the mobile applications may be running on a virtual machine on the headset or on the physical mobile device. With all of these embodiments, an interface layer is needed to bridge the input/output between the virtual mobile device on the artificial-reality device and the native mobile application. For example, an interface layer executing on the AR/YR/MR headset may perform a first translation of sensor data corresponding to a user's input or instructions. For example, the first translation may comprise converting a series of coordinates into a vector and determining where the vector intersects with a surface of a virtual mobile device. The intersection, which may correspond to an input, may then be mapped to a corresponding input event that is consumable by the native mobile application.

While the foregoing examples virtualize users' own mobile phones on their artificial-reality devices, this disclosure may be extended to other use cases. As an example and not by way of limitation, the mobile application may be an application for a consumer electronics store. In particular embodiments, a mirror copy of the application is operatively coupled to a server of the consumer electronics store which hosts the “real” application. When a user enters the electronics store, the user may see a mobile device. If the user chooses to interact with the mobile device, a virtual representation of the device and its applications may be presented to the user via the user's AR/VR/MR headset. The user may then interact with the mirror copy of the application through their AR/VR/MR headset, which is executing on a server. Different users in the store may simultaneously interact with different instances of the virtual mobile application without affecting one another. This allows a demo device placed in the store to be scalable. In particular embodiments, data synchronization between the mirror application and the real application occurs so that actions taken in the mirror application are reflected in the real application on the physical mobile device. In other embodiments, the mirror application executes independently from the state of the application on the physical mobile device. In particular embodiments, once a user purchases a mobile device, the login to the mobile device may be synchronized across the device ecosystem of the user, which may comprise one or more real mobile devices and one or more virtual mobile devices. The mobile device would then be personalized to the user. In this manner, when users wear their AR/VR/MR headset, they would be able to virtually access their mobile phones and their applications and content. For example, when a virtual version of a photo application is launched on the AR/VR/MR headset, the application would have access to the user's photos stored on the cloud by using the synchronized login information. Edits to the photos made via the AR/VR/MR headset would be stored on the cloud, and the user would be able to see the changes via the physical mobile device and application.

In particular embodiments, the user may register with the server to link the user's artificial-reality device and mobile device, and the user's account may be associated with any number of mobile applications that the user wishes the server to host for the user. Registration may be based on login ID, for example, so that the server could link the user's devices and create a seamless user experience. When the user is wearing an AR/VR/MR headset, the user may log into their account with the server and ask the server to launch any of the applications that are on the user's linked mobile devices. The server may then run the selected application using the virtual machine and transmit each frame generated by the application to the user's AR/VR/MR headset.

As previously mentioned, in particular embodiments, the mobile application may be hosted on a physical mobile device instead of a server. The physical mobile device is operatively connected to the AR/VR/MR headset (e.g., via any suitable wired or wireless connection) and may be responsible for executing a desired mobile application. An interface layer, which may be implemented as a service layer on the mobile device and/or the headset, may perform one or more translation steps comprising translating the received sensor data from the AR/VR/MR headset into mobile-application-compatible data which may be input into a mobile application.

In particular embodiments, the mobile application may be hosted on the AR/VR/MR headset. To support mobile applications that are native to a different operating system and/or platform, the AR/VR/MR headset may include a virtual machine that emulates the operating system or platform on which those mobile applications can operate. As discussed in further detail elsewhere herein, an interface layer may be configured to bridge inputs/outputs between mobile applications executing within the virtual machine and the virtual counterparts in virtual reality.

In particular embodiments, a user authentication of their account is performed by authenticating the user wearing the AR/VR/MR headset and transmitting the authentication certificate to the virtual mobile application. As an example and not by way of limitation, an AR/VR/MR headset may authenticate a user through biometric methods, such as through a fingerprint scanner or a facial recognition camera of the AR/VR/MR headset. As another example, the AR/VR/MR headset may authenticate the user by a passcode entered by the user and/or two-factor authentication techniques. In particular embodiments, the AR/VR/MR headset sends an authentication certificate to the virtual mobile device so that the user is not required to log into their account of the mobile application of the virtual mobile device.

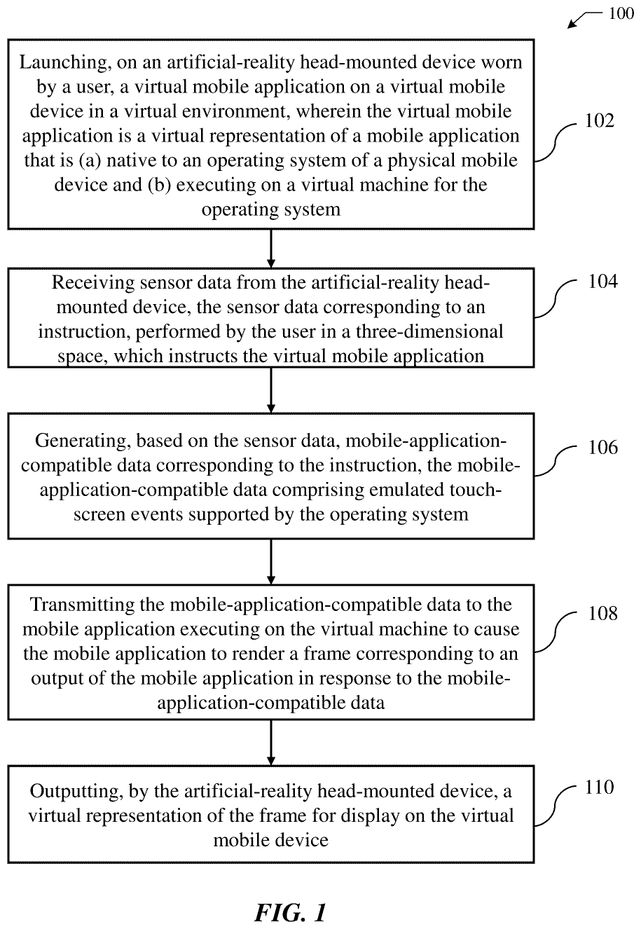

FIG. 1 illustrates an example method 100 for translating inputs from an artificial-reality headset into an input capable of being understood by a mobile application native to a mobile device. At step 102, a computing system may launch, on an artificial-reality head-mounted device worn by a user, a virtual mobile application on a virtual mobile device in a virtual environment. The virtual mobile application may be a virtual representation of a mobile application that is (a) native to an operating system of a physical mobile device and (b) executing on a virtual machine for the operating system. At step 104, the computing system may receive sensor data from the artificial-reality head-mounted device, the sensor data corresponding to an instruction, performed by the user in a three-dimensional space, which instructs the virtual mobile application. At step 106, the computing system may generate, based on the sensor data, mobile-application-compatible data corresponding to the instruction. The mobile-application-compatible data may include emulated touch-screen events supported by the operating system. At step 108, the computing system may transmit the mobile-application-compatible data to the mobile application executing on the virtual machine to cause the mobile application to render a frame corresponding to an output of the mobile application in response to the mobile-application-compatible data. At step 110, the artificial-reality head-mounted device may output a virtual representation of the frame for display on the virtual mobile device.

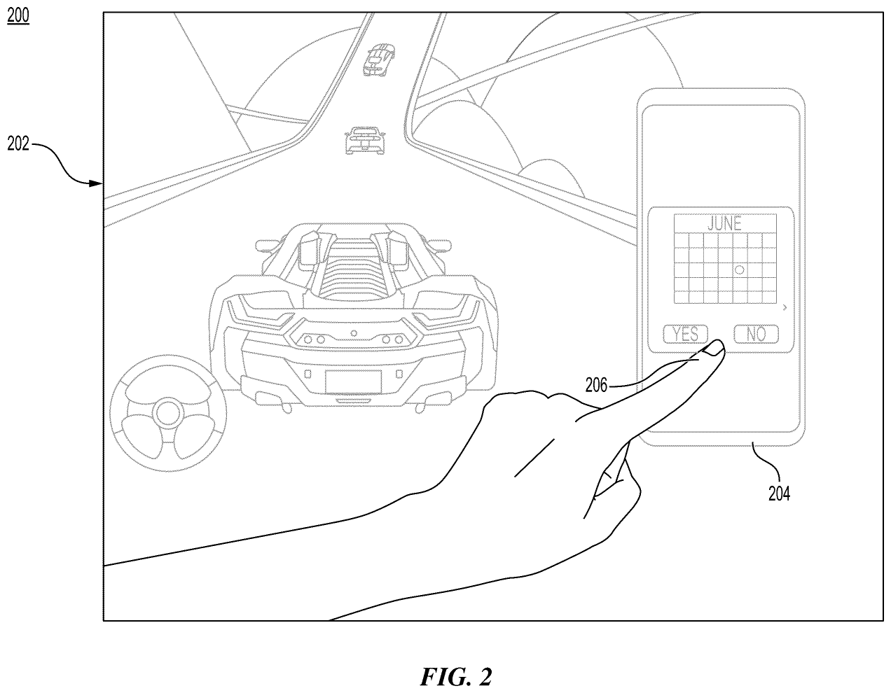

FIG. 2 illustrates an example view 200 of a virtual environment 202. In particular embodiments, a user is immersed in a virtual environment 202 while playing a virtual reality game, such as a car-racing game as depicted in FIG. 2. In particular embodiments, while immersed in the virtual environment, the user receives a notification (e.g., a calendar invitation) on their mobile device. In particular embodiments, the computing system of the artificial-reality device may launch, on an artificial-reality head-mounted device worn by a user, a virtual mobile application on a virtual mobile device in a virtual environment. The virtual mobile application is a virtual representation of a mobile application that is native to an operating system of a physical mobile device of the user. For example, the virtual mobile application may be a calendar application. A virtual mobile device 204 appears in the virtual reality environment, displaying the calendar invitation. In the example shown, the virtual mobile device 204 is head-locked to the user's display (i.e., the device 204 is anchored to a portion of the user's field of view, regardless of where the user looks). In other embodiments, the virtual mobile device 204 could be anchored relative to the virtual world (e.g., on the dashboard of the user's virtual car) or anchored to the user's right hand. On the virtual mobile device 204, the user could use mobile applications (“applications”) that are designed to run natively on the operating system of a physical mobile device. The applications, however, are not actually installed or running on the AR/VR/MR headset. Instead, the applications may be running on a server, which may be tasked with processing inputs from the user's AR/VR/MR headset, rendering a frame by the processed input, and providing the rendered frames to the AR/VR/MR headset. Without having to take off their AR/VR/MR headset, the user may respond to the calendar invitation on the virtual mobile device 204. Since the virtual calendar application is functionally equivalent to the calendar mobile application one on the user's phone, the user would be familiar with its features. Furthermore, since the virtual calendar application is linked on the backend with the virtual calendar on the user's mobile device, the user's calendar data could be viewed and edited on both the virtual calendar application and the actual calendar device. In particular embodiments, the virtual mobile device comprises a mirror of the application library of a physical mobile device of the user.

The virtual mobile application may also launch automatically. For example, in particular embodiments, the computing system may launch the virtual mobile application on the virtual mobile device in response to a determination that a mobile device of the user received a notification corresponding to a mobile application. For example, the virtual calendar application on the virtual mobile device may launch in response to a user receiving a calendar notification on their physical mobile device. In cases where the calendar notification is triggered by a calendaring server, the server could push the notification to all of the user's calendar application, including the virtual calendar application and the calendar application on the user's physical device. In cases where the calendar notification is triggered locally on the user's physical device, the calendar application may relay the notification to the virtual application (e.g., via the server associated with the artificial-reality headset). This results in the user receiving a notification from the calendar application on their virtual mobile device.

In particular embodiments, the computing system may receive sensor data from the artificial-reality head-mounted device. The sensor data may correspond to an action by a user in a three-dimensional space, or an instruction performed by the user in a three-dimensional space, which instructs the virtual mobile application. As an example and not by way of limitation, the user may respond by using their finger 206 to point to a particular area of the virtual mobile device 204. For example, a user may respond with their finger or controller by pointing to the “YES” or “NO” virtual buttons of the virtual mobile device 204. Through hand-tracking or controller-tracking techniques, a ray may be cast from the user's fingertip or controller. For example, for controller tracking, the computing system may receive, from one or more sensors of a hand-held controller associated with the AR/VR/MR head-mounted device, one or more of position data, orientation data, gesture data, or button activation data associated with a button, trigger, or joystick of the hand-held controller. The computing system of the artificial-reality device may also capture images of the controller and estimate its pose in three-dimensional space. Once that's determined, the device may cast a ray from the pose of the controller. Since the artificial-reality device knows the location and orientation (or pose) of the virtual mobile device hosting the virtual mobile application, the device could compute a location at which the ray intersects the virtual mobile application. This allows the user to interact with the virtual mobile device more easily in virtual reality.

The artificial-reality device may alternatively support a variety of different user-interaction techniques suitable for the metaverse. For example, the artificial-reality device may use outward-facing cameras to track the user's hands. One or more cameras associated with the AR/VR/MR headset may capture images of the user's hands. Through keypoint-detection techniques, the device could extract keypoints of the user's hands and/or arms (e.g., predetermined locations on hands or arms, such as joints) in the captured images and fit them to a predetermined hand model to generate a pose estimate for the user's hands and arms. The hand-tracking data, together with the device's knowledge of the location and orientation of the virtual mobile device and/or virtual mobile application, may be used by the device to determine how the user's hands are interacting with the virtual mobile device and/or virtual mobile application. In yet another embodiment, the user may issue instructions via voice commands, in which case the computing system would receive, from one or more audio sensors, audio data from a user corresponding to an action on to be performed by the virtual mobile device and/or virtual mobile application. A speech recognition module may process the audio data to determine the user's spoken instructions. While several specific examples of user-interfacing techniques have been described, one of ordinary skill in the art would appreciate that other types of user-interfacing techniques suitable for virtual reality may be employed as well.

User-interfacing techniques that are suitable for the metaverse may be different from the conventional techniques for interfacing with a physical mobile device. Such devices typically rely on a touch-screen interface, on which the user may tap, swipe, or pinch. A mobile application native to a mobile device would be designed to handle such inputs detected by the operating system of the mobile device. However, if the mobile application is instead running on a virtual machine and a virtual representation of the application is being presented to the user in virtual reality, the application would no longer be able to process the types of input events that the user issued in virtual reality. For example, AR/VR/MR headsets typically receive user inputs in a three-dimensional form. For example, a user input may comprise the x, y, and z coordinates of a fingertip of the user. Another user input may comprise a ray cast from a user's fingertip in a three-dimensional space. Another user input may comprise gestures made by a hand or finger. User inputs are detected by the AR/VR/MR headset and captured as sensor data. While such inputs may be readily consumable by applications native to an AR/VR/MR headset, they are not consumable by a mobile application native to a mobile phone. Mobile phones generally receive two-dimensional inputs—for example, touches or swipes on a two-dimensional surface of the mobile device. Therefore, a native mobile application designed to run on a mobile phone may not have the necessary programs or logic to process instructions given in virtual reality. Thus, particular embodiments described herein provide an interface for translating inputs and outputs between the mobile application and its virtual counterpart that is presented to the user in virtual reality.

The interface layer may be configured to translate input instructions received in the metaverse into instructions that can be processed by a mobile application native to a mobile phone. As an example and not by way of limitation, the artificial-reality headset may detect sensor data, including any data gathered using sensors of the headset, such as IMUs (gyroscope, accelerometer, magnetometer), cameras, ambient light sensor, GPS, infrared sensors (used for tracking position and movement of the controllers), depth sensors, eye tracking, touch capacitive sensors (where is the user's finger resting on the controller), or hand controllers (joystick) associated with the AR/VR/MR headset. These VR/MR/AR input mechanisms are designed to allow the user to interact in a three-dimensional space. The user may use these VR/MR/AR input mechanisms to interact with the virtual mobile device displayed by the headset. For example, the user may use a virtual laser pointer to point to a portion of the virtual mobile device that the user wishes to engage with. As another example, ray may be cast from a finger of the user or a hand-held controller to determine the location where the ray intersects with the virtual mobile device, to determine the type and/or location of the input. The pose of the controller and hand of the user may be determined using controller-tracking or hand-tracking technology. Although this disclosure describes interacting with a virtual mobile device in a particular manner, this disclosure contemplates interacting with a virtual mobile device in any suitable manner, such as through hand gesture or movements, wrist gestures or movement, eye tracking, hand-held controller tracking, or audio.

In particular embodiments, sensor data may further that indicate the user's instructions to the virtual mobile application. For example, sensor data may include a location in the virtual environment where the hand-held controller, hand, or finger intersects a region in the virtual environment where the virtual mobile device is located. As an example and not by way of limitation, the AR/VR/MR headset may cast a ray from the finger 206 of the user and perform intersection testing to determine where the ray intersects with the virtual mobile device. As the ray extends into the virtual environment, it is continuously tested for intersections with three-dimensional objects or surfaces within the VR scene. This intersection testing is often done using geometric calculations, such as ray-plane, ray-sphere, or ray-mesh intersection tests.

In particular embodiments, the computing system of the artificial-reality device may generate, based on the sensor data, mobile-application-compatible data corresponding to the detected instruction received in virtual reality. For example, the mobile-application-compatible data may include emulated touch-screen events supported by the operating system of a mobile phone. As an example and not by way of limitation, the computing system may translate the received sensor data (e.g., data comprising the location wherein a ray cast from finger 206 intersects with the virtual mobile device) into a touch event on a surface of a mobile screen. As an example and not by way of limitation, if the user casts, in three-dimensional space, a ray that intersects the virtual mobile phone, the interface layer may compute a coordinate (x,y) within the coordinate system of the virtual mobile phone at which the intersection occurred. The interface layer may then translate the input into a two-dimensional touch event specifying that a corresponding location (x′, y′) on the mobile application has been effectively “touched” by the user, even though the user did not in fact use a finger to touch that location. The touch event is consumable by the mobile application native to a mobile phone, and is therefore referred to as mobile-application-compatible data. Mobile-application-compatible data may include one or more of: a tap on a mobile display, a swipe on a mobile display, an IMU input, a GPS input, an audio input, a camera input, or any other inputs that a native mobile application may be configured to process. For example, a swipe event on a mobile display may be translated from a user's swinging arm gesture in front of the virtual mobile device (e.g., arm swinging from left to right is translated into a touch-screen swipe event from left to right). Although this disclosure describes mobile-application-compatible data in a particular manner, this disclosure contemplates mobile-application-compatible data in any suitable manner in which a mobile phone may process an input.

As used herein, “translation step” refers to any processes for processing sensor data received from an AR/VR/MR headset into a mobile-application-compatible data capable of being understood by a mobile application. The translation step may occur on the AR/VR/MR headset, by a server, or both. In particular embodiments, translation step may occur on the AR/VR/MR headset. The headset may then transmit the two-dimensional input to the server, which could in turn provide the two-dimensional input to the virtual machine running the application and thereby interacting with the app.

Certain mobile application may be configured to process data from sensors of the physical mobile device. For example, a mobile application native to a mobile phone may be configured to access the phone's image, sound, depth, IMU, and/or wireless data. However, when the mobile application is running within a virtual machine and presented by an artificial-reality device as a virtual mobile device, the mobile application would not have access to the sensors of a physical mobile device. Simply sending sensor data captured by the artificial-reality headset to the mobile application would be incorrect. The mobile application is supposedly running on a virtual mobile device different from the artificial-reality headset, so the virtual mobile device would capture sensory signals that are different from signals captured by the headset. For example, a virtual camera's viewpoint on the virtual mobile device would be different from the physical camera's viewpoint of the artificial-reality headset. As another example, the headset's IMU may indicate that the user is stationary, even though the virtual mobile phone anchored to the user's hand may be swinging wildly. Thus, in particular embodiments, the interface layer would simulate sensory data that would be captured by the virtual mobile device and send the simulated sensory data to the mobile application.

The computing system of the artificial-reality device may simulate sensor data for the virtual mobile device in a variety of ways. For image data, the computing system may first determine the pose (i.e., location and orientation) of the virtual mobile device. Based on the pose, the computing system would be able to compute the viewpoint of a virtual camera of the virtual mobile device. The computing system may then render an image of the virtual environment from that viewpoint. The rendered image would then be a simulated image capture that would be provided to the mobile application. In a similar manner, the computing system may determine a viewpoint of a virtual depth sensor on the virtual mobile device and compute the depth of the virtual environment as observed from the perspective of the virtual depth sensor. For IMU data, the computing system may track the pose of the virtual mobile device over time and use a physics model to compute the device's linear and angular acceleration and velocity. For sound, the computing system may use acoustic spatial computing techniques to simulate audio signals that would be detected by the virtual mobile device. The simulated audio signals could be audio that is heard in virtual reality (e.g., the engine sound of a car in the racing game shown in FIG. 2). The audio signals may also be real-world sounds, but as detected by a virtual microphone of the virtual mobile device. The computing system may perform the simulation by detecting real-world audio signals using the headset's microphone, modeling the detected real-world audio signal, and reprojecting the modeled acoustics to a virtual microphone on the virtual mobile device. Whether real-world sensor signals or virtual sensor signals are desired may be determined by the mobile application. In a similar manner, wireless signals may also be simulated using physics models of wireless signals. For the GPS location of the virtual mobile device, the computing system may compute the real-world location of the headset and offset it by a spatial relationship between the headset and the known location of the virtual mobile device relative to the user. Alternatively, if the virtual GPS location of the virtual mobile device is desired, the computing system may use the virtual location of the user in the virtual environment, which is known to the computing system, and offset it by the known location of the virtual mobile device relative to the user. The aforementioned simulated sensory data of the virtual mobile device are more generally referred to as mobile-application-compatible data.

In particular embodiments, the computing system of the artificial-reality device may transmit the mobile-application-compatible data to the mobile application, which may be running on a virtual machine or another device. For example, input or instruction data, which have been translated into one or more touch events, may be transmitted to the mobile application for native processing. The simulated sensory data of the virtual mobile device (e.g., images, IMU, depth, sound, etc.) may be transmitted to and processed by the mobile application without the application knowing that the sensory data is simulated. For example, a social media mobile application may receive a simulated photograph of the user's virtual environment, taken using the virtual camera of the virtual mobile device.

In particular embodiments, the computing system may receive text data from a native virtual keyboard of the AR/VR/MR head-mounted device and transmitting the text data to the mobile application on a virtual machine. In particular embodiments, a user need not rely on a keyboard of a virtual mobile device, which may be difficult to interact with. Instead, the headset may detect that the user wishes to type on the virtual mobile device and, in response, surface a native keyboard of the AR/VR/MR head-mounted device. For example, when the virtual mobile device displays a keyboard, the headset may display its native keyboard, which could be easier to type on in VR/MR/VR. The headset may transmit the text typed by the user to the server, which in turn may pass the text input to the mobile application running on the virtual machine.

In particular embodiments, the mobile application may render a frame corresponding to an output of the mobile application, which may be performed in response to the mobile-application-compatible data. For example, the mobile application may receive the mobile-application-compatible data, process the mobile-application-compatible data, and render one or more frames as a result. For example, in the hypothetical scenario depicted in FIG. 2, the headset computes the 3D location at which a ray from the finger intersects with a location corresponding to the “YES” virtual button of the calendar application to a server; an interface layer translates the 3D location of intersection to a tap event with a 2D location within the coordinate system of the mobile application; the mobile application receives the mobile-application-compatible data (the tap event) and determine that the user has tapped the “YES” button; and the mobile application renders a frame comprising textual or graphical information indicating a confirmation that an event has been added to the user's calendar.

In particular embodiments, the system on which the mobile application is running may then transmit, to the artificial-reality head-mounted device, the frame for display on the virtual mobile device. For example, in the hypothetical scenario depicted in FIG. 2, the server would send the rendered frame, e.g., a frame comprising textual or graphical information indicating a confirmation that an event has been added to the user's calendar, to the user's AR/VR/MR headset for display on the virtual mobile device 204. In particular embodiments, the AR/VR/MR headset determines one or more of a pose of the user or the location of the hand or hand-held controller of a user, to determine the location of the virtual mobile device on which to display the rendered frame.

As depicted in FIG. 2, the virtual mobile device 204 appears as a floating device in the virtual environment. However, any suitable method of displaying a virtual mobile device may be utilized. As an example and not by way of limitation, the virtual mobile device may be displayed on or proximate to a user's hand. As an example and not by way of limitation, the virtual mobile device may be head-locked or anchored to a point in the virtual environment. As an example and not by way of limitation, the virtual mobile device may be fixed to a particular view of the user. As an example and not by way of limitation, the virtual mobile device may float in a space in front of the user. Each frame received from the server may be used as a texture for the virtual mobile device. Depending on the relative pose between the user's viewpoint and the virtual mobile device, the display of the virtual mobile device may be rendered based on the texture.

As described above, the virtual mobile device may include virtual sensors that correspond to physical sensors of a physical mobile device. For example, the virtual mobile device may have a virtual camera. The virtual camera may have a viewpoint which is mapped to the position of the virtual camera in the virtual space. Sensor data captured by such a virtual camera may be sent to the mobile application and appear as if it is from a physical camera. For example, a user may attend a concert in a virtual environment, access a virtual mobile device within the virtual environment, launch a camera application on the virtual device, snap a photo of the virtual concert stage, take a selfie with their own and their friends' avatars, and then share the photos in a social-media application on her phone. Notably, when the native camera application is launched, the image that it captures may not be the images captured by the physical cameras of the headset. Instead, the headset may determine the position and orientation of the virtual phone in the virtual world, capture a scene of the virtual world from the viewpoint of the virtual phone, and send that captured scene to a server. The server may then have access to the image of the virtual world and allow other native applications running on the virtual machine to process the image (e.g., editing, sharing, etc.).

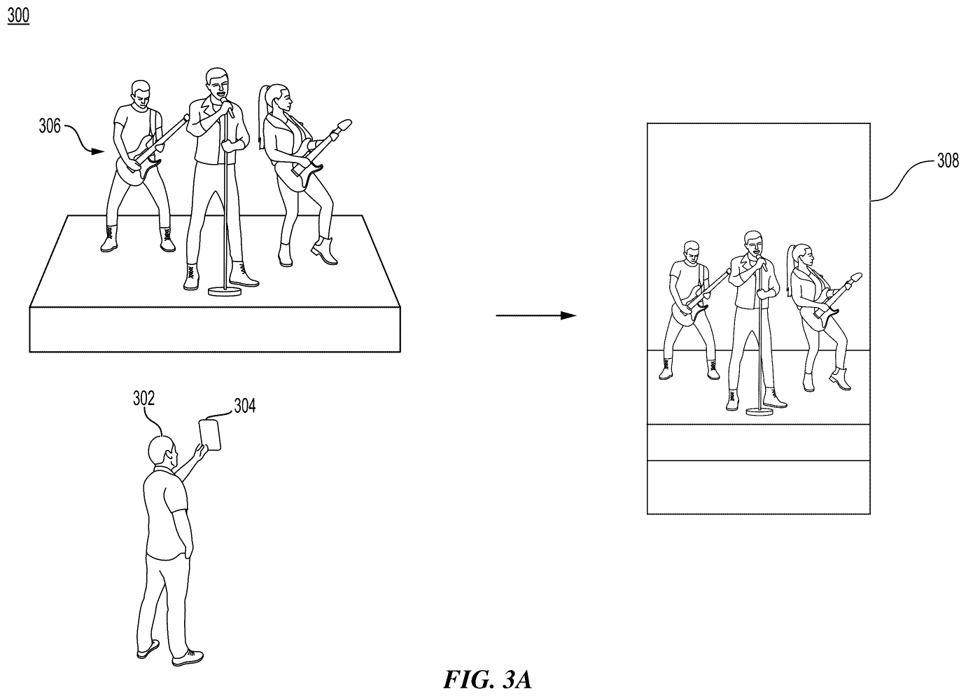

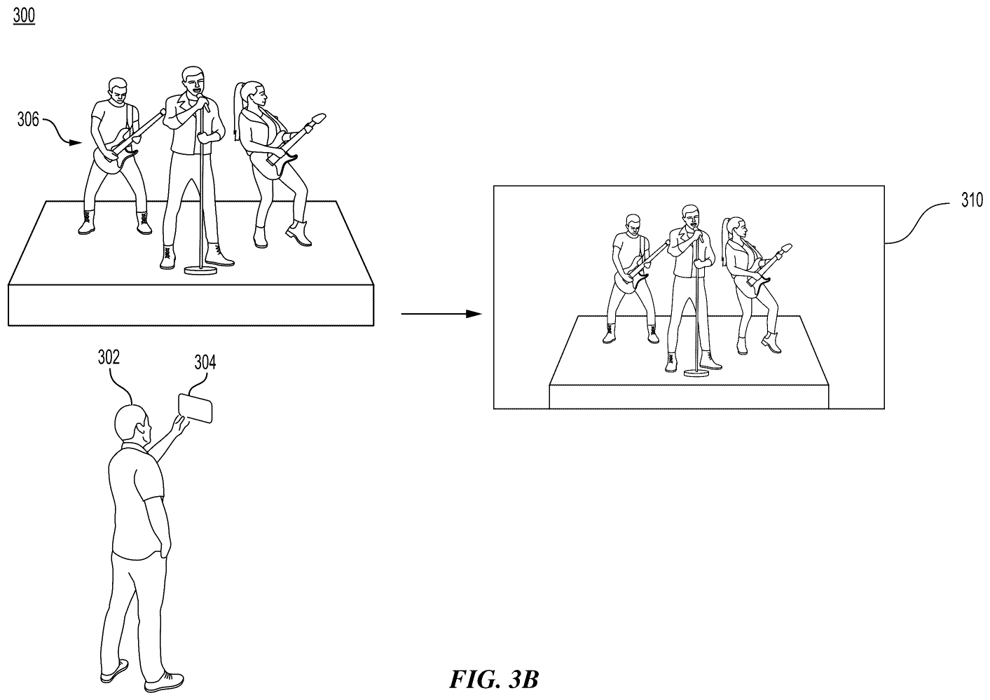

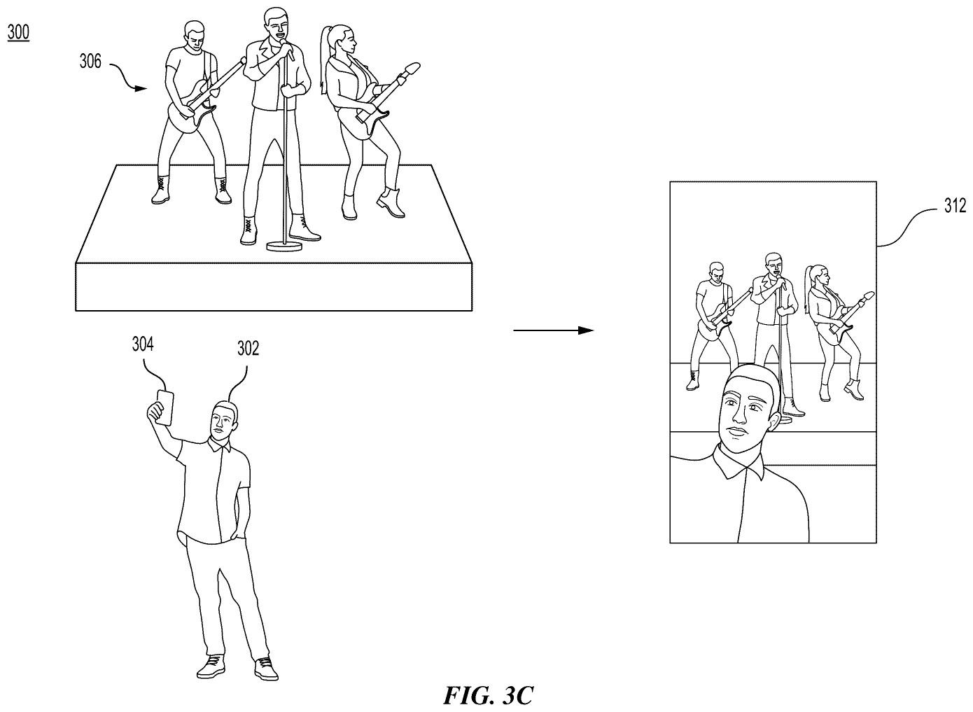

FIGS. 3A-3C illustrate an example view of an artificial reality environment 300, the virtual environment comprising an avatar 302 corresponding to a user, a virtual mobile device 304, and a virtual concert 306. A user may wish to take a picture of the virtual concert and direct their avatar 302 to access their virtual mobile device 304 and launch a camera application on their virtual mobile device. In the example shown, the virtual mobile device 304 is anchored to the left hand of the avatar 302. This may be achieved by the computing system determining a location of a hand, finger, or hand-held controller of the user using any suitable computer-vision tracking techniques. For example, the AR/VR/MR headset tracks the location of one or more hands of avatar 302 to determine the location to display the virtual mobile device 304. The location and orientation of the device 304 would then be used to determine a viewpoint of the virtual camera, which is located at a predetermined location on the virtual mobile device 304. Thus, based on the pose of the virtual mobile device 304, the computing system would determine a viewpoint of the virtual camera of the virtual mobile device. The scene that is visible from the viewpoint of the virtual camera would be different from a viewpoint from the headset. For example, the view of the headset may display an entire concert scene with a three-person band 306. However, the user may wish to only take a picture in which the three band members fill the field of view of the virtual camera and without including the sides of the stage which are empty. The user may do so by orienting the virtual mobile device 304 so that its field of view only captures the intended band members.

Upon receiving an input to generate an image, the computing system may generate, based on the viewpoint of the virtual camera of the virtual mobile device, an image of the virtual environment. For example, a user wearing an AR/VR/MR headset may use their finger to “tap” a virtual button causing the camera application to capture an image. As depicted in FIG. 3A, avatar 302 uses a camera application on virtual mobile device 304 to take a picture of the virtual concert 306. The captured image is depicted in image 308. As depicted in FIG. 3A, the virtual mobile device 304 is in a portrait orientation and image 308 is captured in portrait orientation. In particular embodiments, the AR/VR/MR headset performs a layer of abstraction to determine whether the user has swiped, tapped, or performed some other function on the virtual mobile device.

In particular embodiments, the image 308 is sent to a server hosting a mobile application, and the camera application interprets the camera input as a real-world image captured by a real camera. Further, the user may wish to interact with the photo, such as editing the photo using one or more photo-editing applications on their phone. For example, the user may open a photo-editing mobile application on their virtual mobile device to increase the saturation of the image, which corresponds to a series of taps and swipes a user may make on their phone. The taps and swaps corresponding to the image edit may be sent to the server, causing the server to input mobile-application-compatible data to a photo-editing software on the server (e.g., a swipe on a phone editing application which causes an increase in the contrast of the photo), rendering a frame comprising the edited image, and transmitting the image to the AR/VR/MR headset for display on the virtual mobile device. In particular embodiments, to determine how and where to display the frame, the AR/VR/MR headset determines the location of the user's hand(s) and/or the location of the virtual mobile device.

In particular embodiments, the captured or edited image may be stored in the photo gallery of the AR/VR/MR headset. In other embodiments, the captured or edited image may be stored in the file system of the virtual mobile device 304. In particular embodiments, the captured or edited image may also be stored in the file system of the real mobile device.

In particular embodiments, a user may wish to capture an image of the virtual concert in landscape orientation. The user may rotate the virtual mobile device 304 into a landscape orientation. As depicted in FIG. 3B, avatar 302 operates virtual mobile device 304 in a landscape orientation. When the avatar 302 holding their virtual mobile device 304 in landscape orientation, the computing system may generate a simulated IMU signal corresponding to the change in orientation of the virtual mobile device. The simulated IMU signal is sent to the mobile application, which may be running on the server, to cause the mobile application to change the state of its orientation to landscape mode. An image 310 of the concert 306 may then be taken in a manner similar to the process described with reference to FIG. 3A above.

More generally, IMU events may be derived from manipulating the virtual camera in a virtual scene. In particular embodiments, the server comprises a physics engine which translates sensor data into an IMU event. For example, sensor data such as hand-tracking data may detect a partial wrist rotation, akin to the natural movement a user may perform in real life to rotate an object approximately 90 degrees. The movement may be translated into an IMU event similar to one that the virtual mobile device would have detected had it been a physical device held in the user's hand. In another embodiment, IMU signal may be computed based on tracking data associated with the virtual mobile device, as described in more detail elsewhere herein. In yet another embodiment, IMU signals that would trigger the mobile application the change from portrait mode to landscape mode may be generated based on other contextual information detected by the artificial-reality device. As an example and not by way of limitation, the way a person holds their phone (e.g., with one hand or two hands, as detected using hand-tracking techniques) may correspond to whether a person is holding their phone in landscape or portrait orientation. For example, a user may typically use one hand to capture an image in portrait orientation, and use two hands to capture an image in landscape orientation. As an example and not by way of limitation, the hand-held controller orientation may also change in accordance with the orientation of the phone. In particular embodiments, the hand-held controller may include buttons which allow a user to toggle between landscape or portrait orientation. Once the artificial-reality device detects that the user wishes to change the virtual device's orientation, it may generate a corresponding simulated IMU signal that, when consumed by the native mobile application, would cause it to change from portrait mode to landscape mode. As used herein, IMU events are one of many types of mobile-application-compatible data. Other mobile-application-compatible data may include taps, swipes, data from proximity sensors, data from light sensors, GPS and location data, audio inputs, camera inputs, and biometric inputs. Although this disclosure describes deriving mobile-application-compatible data in a particular manner, this disclosure contemplates deriving mobile-application-compatible data in any suitable manner.

In particular embodiments, a user may wish to take a selfie at a virtual concert. FIG. 3C depicts an avatar 302 using a virtual mobile device 304 to take a selfie at virtual concert 306, generating image 312. For example, a user may press a virtual button to cause the camera application to switch between the front-facing camera and the rear-facing camera. In a similar manner as described with reference to FIG. 3A, the computing system may estimate the pose of the virtual mobile device 304 and determine a viewpoint of the rear-facing camera. When the user captures an image, the viewpoint of the rear-facing camera of the virtual mobile device would be used to render the image 312, which includes the user's avatar 302 in front of the virtual band members 306 in the background.

In particular embodiments, a user may use their virtual phone to record virtual audio at a virtual concert. For example, a virtual concert may have virtual audio sources, and a user may place their virtual mobile device near the virtual audio source to record the audio accurately. For example, the system may determine the positional audio at the point of the microphone of the virtual mobile device. The headset may transmit sensor data comprising inputs of the user corresponding to a “start” and “stop” command on an audio recorder, as well as the audio at the location where the avatar is holding the virtual mobile device.

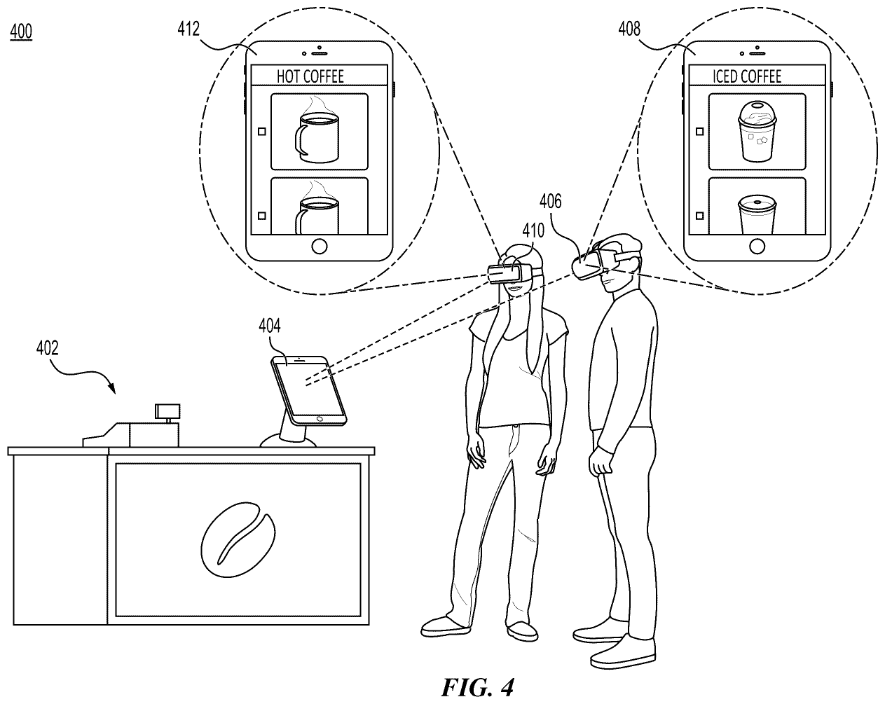

FIG. 4 illustrates an example mixed reality environment 400. A real-world coffee kiosk 402 has a tablet 404 at the kiosk. The tablet 404 is equipped with a software application which enables a user to browse a coffee menu, read about the coffee origin, read the nutritional information of each drink, and order a food or drink item. A first user wearing headset 406 and a second user wearing headset 410 are in proximity to the coffee kiosk. While in an augmented reality environment, the first user and the second user see a communication link at the tablet 404 which enables the users to each launch a software application of the coffee kiosk on their respective headsets. In particular embodiments, the computing system performs the step: upon a determination that the user is within a predetermined distance from a mobile application on a mobile device, transmitting, to the AR/VR/MR head-mounted device of the user, an invitation to launch the virtual mobile application corresponding to the mobile device. For example, the predetermined distance may be a distance in which a real-world user can view the physical tablet.

In particular embodiments, the computing system performs the step: upon receiving a request from the user to launch the virtual mobile application, launching the virtual mobile application on the AR/VR/MR head-mounted device of the user. For example, when a user is in proximity to the kiosk (e.g., within a viewing distance), the user may see a glint, e.g., a visual indication displayed in the virtual environment indicating that an application is available to launch on the headset. For example, a first user wearing headset 406 may launch a software application of the coffee kiosk and browse their iced coffee menu 408. At the same time, a second user wearing headset 410 may launch a software application of the coffee kiosk and browse their iced coffee menu 412. Each user has a unique instance of the software application to access, i.e., the users are not in a shared version of the software and do not see each other's activities within the application.

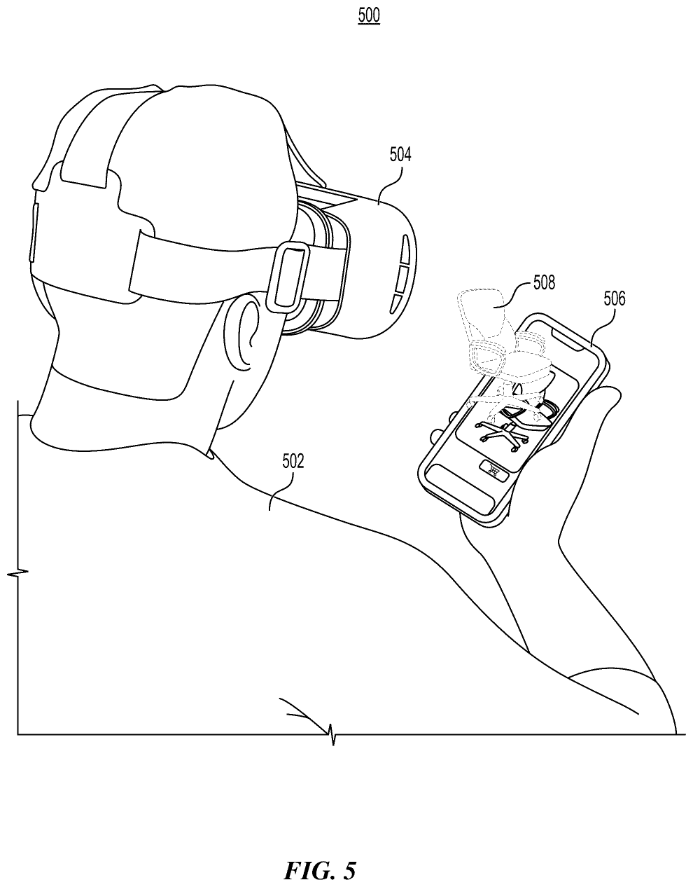

FIG. 5 illustrates an example virtual reality environment 500. For example, a user 502 is wearing an AR/VR/MR headset 504 while also accessing the internet on a mobile device 506. In the physical world, the mobile device 506 running a marketplace application may display a 2D image of the chair on its display. The marketplace application is developed to simply show images on the display when it is running on a traditional mobile device 506. In particular embodiments, the marketplace application may be written with an alternative mode to be used when the application is being used on a virtual mobile device by a user in virtual reality. For example, the marketplace mobile application may be running on a virtual machine hosted by a server or on the physical mobile device 506 but tethered to the headset 504. In either case, when user 502 is in virtual reality while using the marketplace mobile application, the user's headset 504 may inform the marketplace application that it is being used in the virtual reality context. In response, the marketplace application may switch to a different mode that can take advantage of the virtual reality environment. For example, when the application knows it is being used by a virtual mobile device, it may render a hologram 508 of the chair instead of simply displaying a 2D image of the chair. The hologram 508 could spawns on the display of the virtual mobile device. In other embodiments, a user may be wearing an AR/MR headset while using their physical mobile device. While browsing for a chair on the physical mobile device, the marketing mobile application may render a hologram of the chair and send it to the headset for display. The marketplace mobile application may continue to display the 2D image of the chair on the physical device or turn it off.

The mobile application may be executing either locally on the headset, or on a server. In particular embodiments, the mobile application knows that at a particular run time, that it is currently executing in the virtual environment, and so when the user pulls up a listing of a chair, the mobile application will direct the AR/YR/MR headset to render a hologram for the chair.

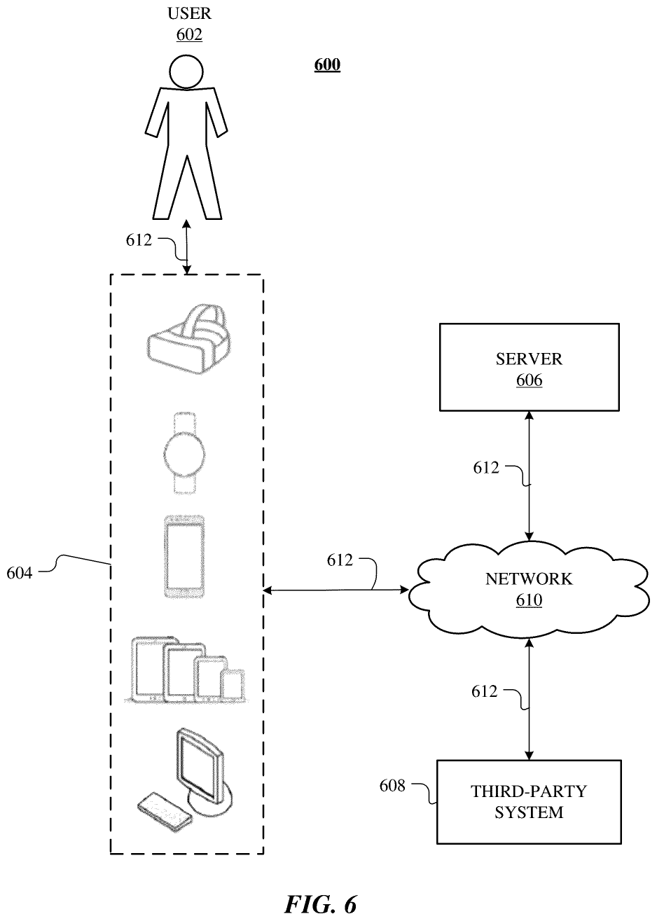

FIG. 6 illustrates an example network environment 600 associated with an AR/YR/MR system. Network environment 600 includes a user 602, a client system 604, a server 606 and a third-party system 608 connected to each other by a network 610. Although FIG. 6 illustrates a particular arrangement of user 602, client system 604, server 606, third-party system 608, and network 610, this disclosure contemplates any suitable arrangement of user 602, client system 604, server 606, third-party system 608, and network 610. As an example and not by way of limitation, two or more of client system 604, server 606, and third-party system 608 may be connected to each other directly, bypassing network 610. As another example, two or more of client system 604, server 606, and third-party system 608 may be physically or logically co-located with each other in whole or in part. Moreover, although FIG. 6 illustrates a particular number of users 602, client systems 604, servers 606, third-party systems 608, and networks 610, this disclosure contemplates any suitable number of users 602, client systems 604, servers 606, third-party systems 608, and networks 610. As an example and not by way of limitation, network environment 602 may include multiple users 602, client system 604, servers 606, third-party systems 608, and networks 610.

In particular embodiments, user 602 may be an individual (human user), an entity (e.g., an enterprise, business, or third-party application), or a group (e.g., of individuals or entities) that interacts or communicates with or over server 606. In particular embodiments, server 606 comprises a virtual machine hosting one or more mobile applications. Alternatively, the mobile application may run on a virtual machine on the artificial-reality headset 604 or on a mobile phone 604 that is connected to the artificial-reality headset 604. An interface layer, which may be implemented as a software layer, may translate user instructions provided via the artificial-reality headset 604 into mobile-application-compatible data, such as, for example, a tap on a mobile display, a swipe on a mobile display, an IMU input, a GPS input, or a camera input. The interface layer may run on the same system where the mobile application is running. In other embodiments, the interface layer for generating mobile-application-compatible data (e.g., translated inputs or simulated sensor data) may reside locally on the headset 604.

Server 606 may be accessed by the other components of network environment 602 either directly or via network 610. In particular embodiments, server 606 may include an authorization server (or other suitable component(s)) that allows users 602 to opt in to or opt out of having their actions logged by server 606 or shared with other systems (e.g., third-party systems 608), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of server through blocking, data hashing, anonymization, or other suitable techniques as appropriate. In particular embodiments, third-party system 608 may be a network-addressable computing system. Third-party system 608 may be accessed by the other components of network environment 602 either directly or via network 610. In particular embodiments, one or more users 602 may use one or more client systems 604 to access, send data to, and receive data from server 606 or third-party system 608. Client system 604 may access server 606 or third-party system 608 directly, via network 610, or via a third-party system. As an example and not by way of limitation, client system 604 may access third-party system 608 via server 606. Client system 604 may be any suitable computing device, such as, for example, a personal computer, a laptop computer, a cellular telephone, a smartphone, a tablet computer, or an augmented/virtual reality device.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 612 may connect client system 604, server 606, and third-party system 608 to communication network 610 or to each other. This disclosure contemplates any suitable links 612. In particular embodiments, one or more links 612 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 612 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 612, or a combination of two or more such links 612. Links 612 need not necessarily be the same throughout network environment 602. One or more first links 612 may differ in one or more respects from one or more second links 612.

### Artificial Reality Overview

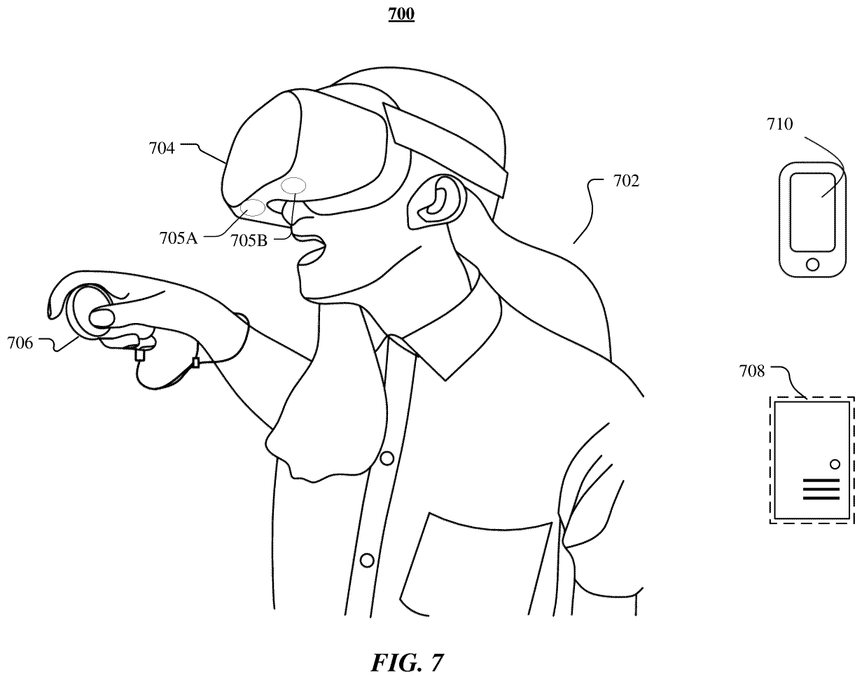

FIG. 7 illustrates an example artificial reality system 700 and user 702. In particular embodiments, the artificial reality system 700 may comprise a headset 704, a controller 706, a computing system 708, and a mobile device 710. A user 702 may wear the headset 704 that may display visual artificial reality content to the user 702. The headset 704 may include an audio device that may provide audio artificial reality content to the user 702. The headset 704 may include an eye tracking system to determine a vergence distance of the user 702. A vergence distance may be a distance from the user's eyes to objects (e.g., real-world objects or virtual objects in a virtual space) upon which the user's eyes are converged. The headset 704 may be referred to as a head-mounted display (HMD). One or more controllers 706 may be paired with the artificial reality system 700. In particular embodiments, one or more controllers 706 may be equipped with at least one inertial measurement units (IMUs) and infrared (IR) light emitting diodes (LEDs) for the artificial reality system 700 to estimate a pose of the controller and/or to track a location of the controller, such that the user 702 may perform certain functions via the controller 706. In particular embodiments the one or more controllers 706 may be equipped with one or more trackable markers distributed to be tracked by the computing system 708. The one or more controllers 706 may comprise a trackpad and one or more buttons. The one or more controllers 706 may receive inputs from the user 702 and relay the inputs to the computing system 708. The one or more controllers 706 may also provide haptic feedback to the user 702. The computing system 708 may be connected to the headset 704 and the one or more controllers 706 through cables or wireless connections. The one or more controllers 706 may include a combination of hardware, software, and/or firmware not explicitly shown herein so as not to obscure other aspects of the disclosure.

The artificial reality system 700 may further include a computer unit 708. The computer unit may be a stand-alone unit that is physically separate from the HMD or it may be integrated with the HMD. In embodiments where the computer 708 is a separate unit, it may be communicatively coupled to the HMD via a wireless or wired link. The computer 708 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by an artificial reality system 700 depends on the capabilities of its computer unit 708.

The HMD may have external-facing cameras, such as the two forward-facing cameras 705A and 705B shown in FIG. 7. While only two forward-facing cameras 705A-B are shown, the HMD may have any number of cameras facing any direction (e.g., an upward-facing camera to capture the ceiling or room lighting, a downward-facing camera to capture a portion of the user's face and/or body, a backward-facing camera to capture a portion of what's behind the user, and/or an internal camera for capturing the user's eye gaze for eye-tracking purposes). The external-facing cameras 705A and 705B are configured to capture the physical environment around the user and may do so continuously to generate a sequence of frames (e.g., as a video).

In particular embodiments, the pose (e.g., position and orientation) of the HMD within the environment may be needed. For example, in order to render an appropriate display for the user 702 while he is moving about in a virtual or augmented reality environment, the system 700 would need to determine their position and orientation at any moment. Based on the pose of the HMD, the system 700 may further determine the viewpoint of either of the cameras 705A and 705B or either of the user's eyes. In particular embodiments, the HMD may be equipped with inertial-measurement units (“IMU”). The data generated by the IMU, along with the stereo imagery captured by the external-facing cameras 705A-B, allow the system 700 to compute the pose of the HMD using, for example, SLAM (simultaneous localization and mapping) or other suitable techniques.

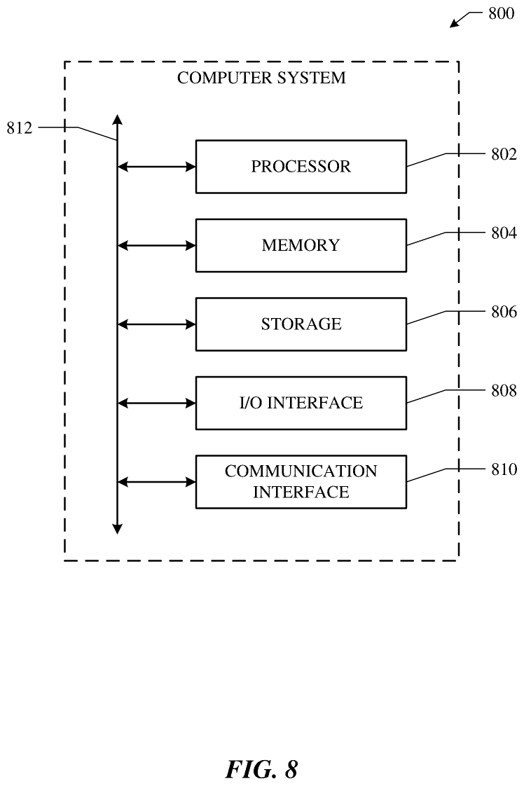

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a Communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, Communication interface 810 includes hardware, software, or both providing one or more interfaces for communication (such as, for example, packet-based communication) between computer system 800 and one or more other computer systems 800 or one or more networks. As an example and not by way of limitation, Communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable Communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable Communication interface 810 for any of these networks, where appropriate. Communication interface 810 may include one or more Communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (iCs) (such, as for example, field-programmable gate arrays (FPGAs) or application-specific iCs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method, comprising:
launching, on an artificial-reality head-mounted device worn by a user, a virtual mobile application on a virtual mobile device in a virtual environment, wherein the virtual mobile application is a virtual representation of a mobile application that is (a) native to an operating system of a physical mobile device and (b) executing on a virtual machine for the operating system;
receiving sensor data from the artificial-reality head-mounted device, the sensor data corresponding to an instruction, performed by the user in a three-dimensional space, which instructs the virtual mobile application;
generating, based on the sensor data, mobile-application-compatible data corresponding to the instruction, the mobile-application-compatible data comprising emulated touch-screen events supported by the operating system;
transmitting the mobile-application-compatible data to the mobile application executing on the virtual machine to cause the mobile application to render a frame corresponding to an output of the mobile application in response to the mobile-application-compatible data; and
outputting, by the artificial-reality head-mounted device, a virtual representation of the frame for display on the virtual mobile device.

2. The method of claim 1, wherein said receiving sensor data from the artificial-reality head-mounted device comprises one or more of:
receiving, from one or more image sensors, data corresponding to a position, movement, or gesture of a hand or finger of the user;
receiving, from one or more sensors of a hand-held controller associated with the artificial-reality head-mounted device, one or more of: position data, orientation data, gesture data, or button activation data associated with a button, trigger, or joystick of the hand-held controller; or
receiving, from one or more audio sensors, audio data from a user corresponding to an action on mobile device.

3. The method of claim 2, wherein said receiving sensor data from the artificial-reality head-mounted device comprises receiving data indicating a location on the virtual mobile application intersected by the hand-held controller, hand, or finger.

4. The method of claim 1, further comprising:
receiving text data input by the user on a native virtual keyboard of the artificial-reality head-mounted device; and
transmitting the text data to the mobile application.

5. The method of claim 1, wherein the mobile-application-compatible data comprises one or more of: a tap event, swipe event, or pinch event.

6. The method of claim 1, further comprising:
receiving a request from the mobile application to access a camera feed;
in response to the request, determining a pose of the virtual mobile device in the virtual environment;
determining a virtual camera viewpoint based on the pose of the virtual mobile device;
rendering one or more images of the virtual environment from the virtual camera viewpoint; and
transmitting the one or more images to the mobile application.

7. The method of claim 6, wherein the virtual camera viewpoint is relative to the virtual environment.

8. The method of claim 6, wherein the pose of the virtual mobile device is determined based on hand-tracking data corresponding to a hand of a user and a defined spatial relationship between the hand and the virtual mobile device.

9. The method of claim 1, further comprising:
upon a determination that the user is within a predetermined distance from the physical mobile device, transmitting, to the artificial-reality head-mounted device of the user, an invitation to launch the virtual mobile device; and
upon receiving a request from the user to launch the virtual mobile device, launching the virtual mobile device on the artificial-reality head-mounted device of the user.

10. The method of claim 1, further comprising:
in response to a determination that the mobile application received a notification, launching, on the artificial-reality head-mounted device, the virtual mobile application on the virtual mobile device and display a virtual representation of the notification.

11. The method of claim 1, wherein the virtual machine executing the mobile application is on a server.

12. The method of claim 1, further comprising:
registering the artificial-reality head-mounted device with the physical mobile device;
identifying a plurality of mobile applications installed on the physical mobile device; and
displaying icons associated with the plurality of mobile applications on the virtual mobile device.

13. The method of claim 12, wherein said launching of the virtual mobile application on the virtual mobile device is triggered by a detection of a user selection of one of the icons associated with the mobile application.

14. One or more computer-readable non-transitory storage media embodying software that is operable when executed to:
launch, on an artificial-reality head-mounted device worn by a user, a virtual mobile application on a virtual mobile device in a virtual environment, wherein the virtual mobile application is a virtual representation of a mobile application that is (a) native to an operating system of a physical mobile device and (b) executing on a virtual machine for the operating system;
receive sensor data from the artificial-reality head-mounted device, the sensor data corresponding to an instruction, performed by the user in a three-dimensional space, which instructs the virtual mobile application;
generate, based on the sensor data, mobile-application-compatible data corresponding to the instruction, the mobile-application-compatible data comprising emulated touch-screen events supported by the operating system;
transmit the mobile-application-compatible data to the mobile application executing on the virtual machine to cause the mobile application to render a frame corresponding to an output of the mobile application in response to the mobile-application-compatible data; and
output, by the artificial-reality head-mounted device, a virtual representation of the frame for display on the virtual mobile device.

15. The media of claim 14, wherein the software is further operable when executed to:
register the artificial-reality head-mounted device with the physical mobile device;
identify a plurality of mobile applications installed on the physical mobile device; and
display icons associated with the plurality of mobile applications on the virtual mobile device.

16. The media of claim 14, wherein the software is further operable when executed to:
receive a requested from the mobile application to access a camera feed;
in response to the request, determine a pose of the virtual mobile device in the virtual environment;
determine a virtual camera viewpoint based on the pose of the virtual mobile device;
render one or more images of the virtual environment from the virtual camera viewpoint; and
transmit the one or more images to the mobile application.

17. The media of claim 16, wherein the pose of the virtual mobile device is determined based on hand-tracking data corresponding to a hand of a user and a defined spatial relationship between the hand and the virtual mobile device.

18. A system comprising:
one or more processors; and
one or more computer-readable non-transitory storage media coupled to one or more of the processors and comprising instructions operable when executed by one or more of the processors to cause the system to:
launch, on an artificial-reality head-mounted device worn by a user, a virtual mobile application on a virtual mobile device in a virtual environment, wherein the virtual mobile application is a virtual representation of a mobile application that is (a) native to an operating system of a physical mobile device and (b) executing on a virtual machine for the operating system;
receive sensor data from the artificial-reality head-mounted device, the sensor data corresponding to an instruction, performed by the user in a three-dimensional space, which instructs the virtual mobile application;
generate, based on the sensor data, mobile-application-compatible data corresponding to the instruction, the mobile-application-compatible data comprising emulated touch-screen events supported by the operating system;
transmit the mobile-application-compatible data to the mobile application executing on the virtual machine to cause the mobile application to render a frame corresponding to an output of the mobile application in response to the mobile-application-compatible data; and
output, by the artificial-reality head-mounted device, a virtual representation of the frame for display on the virtual mobile device.

19. The system of claim 18, wherein the processors are further operable when executing the instructions to:
register the artificial-reality head-mounted device with the physical mobile device;
identify a plurality of mobile applications installed on the physical mobile device; and
display icons associated with the plurality of mobile applications on the virtual mobile device.

20. The system of claim 18, wherein the processors are further operable when executing the instructions to
receive a requested from the mobile application to access a camera feed;
in response to the request, determine a pose of the virtual mobile device in the virtual environment;
determine a virtual camera viewpoint based on the pose of the virtual mobile device;
render one or more images of the virtual environment from the virtual camera viewpoint; and
transmit the one or more images to the mobile application.
